(19) United States
(12) Patent Application Publication
(10) Pub. No.: US 2017/0044643 A1
(43) Pub. Date: Feb. 16, 2017

(54) METHOD AND APPARATUS FOR PRODUCING A STEEL STRIP

(71) Applicant: Voestalpine Precision Strip GmbH, Boehlerwerk (AT)

(72) Inventor: Leander AHORNER, Waidhofen/Ybbs (AT)

(73) Assignee: Voestalpine Precision Strip GmbH, Boehlerwerk (AT)

(21) Appl. No.: 15/304,403

(22) PCT Filed: Apr. 15, 2015
(86) PCT No.: PCT/EP2015/058213

§ 371 Date: Oct. 14, 2016

(30) Foreign Application Priority Data
Apr. 15, 2014 (EP) 14164750.3

(51) Int. Cl. C21D 9/573; C21D 1/667; F27B 9/20; C21D 1/767; C21D 11/00; C21D 1/613; C21D 1/20

(52) U.S. Cl. CPC C21D 9/573; C21D 1/613; C21D 1/667; C21D 1/20; C21D 1/767; C21D 11/005; F27B 9/20; C21D 2211/002; F27D 2009/0008

(57) ABSTRACT

The invention relates to a method and to an apparatus for producing a steel strip, in particular a steel strip having a bainitic microstructure, such as for example a spring steel strip or a punching tool, wherein the steel strip is made to pass continuously through the following treatment steps: austenitization of the steel strip at a first temperature above the austenitization temperature; quenching of the steel strip, by means of a gaseous quenchant, to a lower, second temperature selected in accordance with a desired steel microstructure. According to the invention, the gaseous quenchant is conducted onto the steel strip in such a manner that uniform cooling is achieved over the width of the steel strip.

The present invention relates to a method and to an apparatus for producing a steel strip, in particular a steel strip having a bainitic microstructure, such as for example a spring steel strip or a punching tool.

Spring steel strips or punching tools of this type are commonly produced proceeding from a hot-rolled and pickled carbon-containing steel strip, which is typically firstly cold-rolled to the desired thickness and then subjected to various treatment steps in order to influence the strength properties of the steel strip. Then, the originally wide steel strip is divided longitudinally into individual strips in the desired dimensions and finalized.

For influencing the strength properties, the steel strip is guided through various treatment devices in a continuous process, said steel strip firstly being hardened by heating and subsequent cooling and then being modified in terms of its toughness properties by tempering and cooling. Depending on the heating and cooling profile which the steel strip passes through in the treatment devices, it is possible to produce different microstructures in the material. A particularly preferred microstructure in the quenching and tempering of carbon steels is what is termed the bainite microstructure, which can form during the heat treatment of carbon-containing steel both as a result of isothermal transformation and as a result of continuous cooling. For a transformation which is as complete as possible, it is necessary to observe specific cooling rates and temperatures during the holding time in the furnace for the isothermal or quasi-isothermal transformation.

The German patent application DE 10 2005 054 014 A discloses a method for producing a steel strip with a bainitic microstructure in a continuous process, in which the starting material is austenitized at a temperature above the austenitization temperature, and then the starting material is quenched in a metal bath to a temperature lower than the austenitization temperature and held in a furnace heated by hot air at the transformation temperature for bainite. After the holding phase, the steel strip is cooled to ambient temperature. A typical metal bath which can be used for quenching the steel strip which is at a temperature above the austenitization temperature is a lead/bismuth molten mass.

Disadvantages are associated with the metal bath quenching, however. Owing to the use of heavy metals such as lead and bismuth, there is the risk, during the quenching and tempering of the steel strip, of heavy metal contamination in the form of dust, vapors and spatter both in the immediate working area at the molten bath and also when handling the molten material. Moreover, the workstation may also be contaminated with heavy metals in subsequent working steps owing to spreading and adhesion on the strip surface, in particular on the strip edges. In addition, steel strips treated in this way are unsuitable in numerous fields of application or have to be cleaned or coated by complex methods beforehand. In addition, high costs arise when maintaining and disposing of the molten material and also when disposing of correspondingly contaminated secondary materials, such as for example the strippers arranged downstream of the metal bath.

It is moreover known to use a gas stream for strip cooling following an annealing treatment. Thus, for example, C. Brugnera, La Revue de Métallurgie, vol. 89, no. 12 (Dec. 1, 1992), pp. 1093-1099 describes a method for rapidly cooling a metal strip by means of a gas stream. A bainitic microstructure cannot be produced using the method described by Brugnera, however. Firstly, to this end, the starting temperature of 750-850° C. as mentioned in Brugnera is too low, and, secondly, according to the temperature profile shown therein in FIG. 2, what is described is firstly slow cooling to 650° C. followed by rapid cooling to 400° C. Even this rapid cooling is effected only with a cooling rate of approximately 40° C. per second, and this is too slow for a bainitic microstructure. Moreover, page 1095 describes various cooling methods in which a cooling rate of approximately 80° C. per second is mentioned as the upper limit for gas cooling.

Furthermore, H. Lochner et al. describe, in Stahl und Eisen, vol. 128, no. 7 (Jan. 1, 2008), pp. 45-48, a method for quenching steel strips by means of a hydrogen gas stream for the purpose of martensite formation. In this case, steel strips with a medium and high carbon content are cooled without pre-separation by significantly reduced nozzle spacings, with high gas outlet velocities and an optimized guidance of gas. High-alloy martensitic chromium steels are hardened by two-stage quenching with an associated possibility to influence the flatness of the strips.

It is also the case that the prior art described in Lochner et al. is unsuitable for producing a steel strip with a bainitic microstructure. For this purpose, it is not only necessary for the steel strip to be quenched to a temperature in the bainitization range at a high cooling rate proceeding from a temperature above the austenitization temperature, i.e. above approximately 900° C., but also the temperature in the bainitization range has to be kept as constant as possible in spite of the exothermal transformation of the microstructure.

In order to achieve complete transformation of the supercooled austenite into bainite, it is moreover necessary to make the quenching from the austenitization temperature as uniform as possible over the strip width, to stop the quenching at a temperature in the region of 400° C. and to convert it into isothermal holding at this temperature. This, too, cannot be ensured by the prior art described in Brugnera and Lochner et al. These system designs do not take into account a particular circumstance of the cooling of steel strips, in particular relatively wide strips. Specifically, on account of the additional surface area on the narrow side of the strip, the strip edges cool more rapidly than the rest of the strip region, and a difference in temperature is formed with respect to the strip regions located further toward the center (edge effect). Since it is additionally the case that the heat-dissipating gas can be carried away less effectively over the strip center than at the strip edges, an even higher temperature difference is formed. This gives rise to an inhomogeneous temperature distribution over the strip width. In spite of the slotted nozzles arranged transversely to the strip running direction, a cooling front which is curved transversely to the strip running direction is therefore formed (the strip edges are cooler than the strip center). During the further microstructure formation, an inhomogeneous temperature distribution in the strip can have a negative effect on the microstructure transformation times or microstructure constituents and the volumetric composition thereof. Since the strength and material properties, such as for example toughness, of the bainite microstructure which forms are dependent on the transformation temperature, a difference in temperature between the strip center and the strip edges during the transformation also leads to a difference in strength. A curved cooling front therefore leads to a different distribution of the material properties over the strip width.

Curved cooling fronts during quenching are associated with further disadvantages; these not only concern the hardening of steel strips, but can also generally arise during the cooling of steel strips, for example also during cooling of non-hardenable chromium steels. Particularly in the initial phase of the quenching (i.e. at a still relatively high temperature level), inhomogeneous shrinkage stresses are brought about over the strip width by the curved cooling fronts (tensile stresses at the edges, compressive stresses in the strip center), and said shrinkage stresses can lead to plastic deformation of individual strip regions. In this respect, differences in temperature transversely to the strip running direction during cooling can have a negative effect on the strip flatness.

The present invention is therefore based on the technical problem of specifying a method and an apparatus for producing a steel strip, in particular a steel strip having a bainitic microstructure, such as for example a spring steel strip or a punching tool, in a continuous quenching and tempering process, which is absolutely free of metal bath residues, in particular free of heavy metal residues such as lead or bismuth, and which ensures a high flatness of the strip and a microstructure which is as homogeneous as possible.

This technical problem is solved by the method of present claim 1 and respectively by the apparatus of present claim 13. Preferred embodiments of the method according to the invention and of the apparatus according to the invention are the subject matter of the dependent patent claims.

The invention accordingly relates to a method for producing a steel strip, wherein the steel strip is made to pass continuously through the following treatment steps: austenitization of the steel strip at a first temperature above the austenitization temperature and quenching of the steel strip, by means of a gaseous quenchant, to a lower, second temperature selected in accordance with a desired steel microstructure. The method according to the invention is characterized in that the gaseous quenchant is conducted over the steel strip in such a manner that uniform cooling is achieved over the width of the steel strip.

On account of the use of a gaseous quenchant which is provided according to the invention, heavy metal contamination both of the steel strip and of the work environment is effectively prevented. Furthermore, the quenching and tempering of the steel strip becomes more cost-effective, since the outlay on energy and maintenance which is associated with the use of a heavy metal-containing molten bath and also the postprocessing and cleaning steps required in the prior art can be saved.

The edge effect which arises in the case of gaseous quenching methods is avoided or at least considerably reduced with the method according to the invention, since the quenchant is conducted onto the steel strip in such a manner that uniform cooling is achieved over the width of the steel strip. On a cross section of the strip, the strip temperatures in the strip center and at the strip edges are therefore essentially the same. Curved cooling fronts and the associated disadvantages, such as impairment of the strip flatness and a non-uniform microstructure formation, are therefore avoided or reduced.

The steel strip used may be, for example, a hot-rolled, optionally pickled steel strip, which is cold-rolled to the desired thickness before the heat treatment, in particular the quenching and tempering with the method according to the invention. A typical starting material is a steel strip having a width of 250 to 1250 mm and a thickness of 2 to 4 mm, which is cold-rolled, for example, to a thickness of 0.4 mm to 2.5 mm. The austenitization of the steel strip is effected at a first temperature above the austenitization temperature which is dependent on the composition of the steel strip. Typically, this first temperature lies in the region of 900° C. or above. The dimensions of the austenitization furnace and the speed of transport of the steel strip are chosen in such a way that the steel strip is located in the austenitization furnace for several minutes, for example between 2 and 5 minutes.

After the austenifization, the steel strip is quenched to a lower, second temperature very rapidly, i.e. in the second range. The second temperature and the cooling rate are usually connected with the desired microstructure. If, for example, a steel strip having a bainitic microstructure is desired, the steel strip is quenched to a lower, second temperature quenched in the bainitization range of the steel strip material. The bainitization range, i.e. the temperature at which a bainite microstructure can form in the steel strip, lies below the austenitization temperature and above the martensite starting temperature of the steel strip material. This temperature typically lies in the range of 300° C. to 450° C. Then, the steel strip is held at a temperature in the bainitization range for several minutes, typically 2 to 3 minutes, such that the bainite microstructure can form in the steel strip to the desired extent. Since the bainite microstructure formation is effected by exothermal means, the temperature of the atmosphere in the holding furnace should be controlled, such that a quasi-isothermal formation of the bainite microstructure, i.e. a formation of the bainite microstructure without a significant change in temperature in the holding furnace, can be effected.

In the method according to the invention, it is particularly important especially for the case of the bainite formation that the quenching of the steel strip to a temperature in the bainitization range is reliably ensured, i.e. that the temperature of the steel strip which is set after the quenching is neither too high nor too low, for example already lies in the martensite range. In other cooling methods, too, it is usually important that a predefined temperature profile is observed as exactly as possible. Therefore, the gaseous quenchant is preferably guided in a temperature-controlled circuit. On the one hand, this ensures that the smallest possible loss of gaseous quenchant occurs, such that it is also possible, for example, for relatively expensive gases to be used. On the other hand, the temperature control ensures that the gas can be blown onto the steel strip passing through at an adjustable, constant temperature. To this end, use is preferably made of a jet blower having a plurality of nozzles, which subject the steel strip to a flow of gas preferably both from the top side and from the bottom side.

The individual nozzles of the jet blower are preferably adjustable in terms of their orientation and/or in terms of their flow rate. Optionally, suitable sensors can be used to monitor the temperature of the steel strip downstream of the quenching unit and to correspondingly adapt the jet blower.

It is particularly preferable that the flow rate of the gaseous quenchant is varied over the width of the steel strip, i.e. transversely to the strip running direction. The flow rate of the quenchant is preferably varied in such a way that the cooling power toward the strip edges is lower than in the strip center, such that ultimately a temperature profile which is constant over the strip width is achieved. This ensures that a uniform, for example bainitic, microstructure with a constant hardness or strength is formed throughout the strip.

In addition to a suitable orientation and/or adaptation of the flow rate of a plurality of nozzles, when slotted nozzles are used this can be achieved, for example, by special shaping of the individual slotted nozzles, these being adapted to the curved temperature distribution resulting through the edge effect, specifically in the first cooling region, over the strip width. However, a solution of this nature is technically complex and not very flexible, since the shaping of the slotted nozzles has to be adapted to the respective strip dimensions. The cooling transversely to the strip running direction is therefore preferably achieved by setting or even by controlling the width of the slotted nozzles through which the gas flows, for example by laterally closing or covering part of the openings of the nozzles. Especially in the first cooling region, the temperature distribution can thereby be homogenized over the strip width, and thus shrinkage stresses or instances of plastic deformation can be avoided and the strip flatness or uniform microstructure transformation can thereby be improved considerably. Subsequent processing steps for improving the strip flatness, such as for example straightening of the strip by stretching, can thus be minimized.

The method according to the invention can be used for a wide variety of hardenable and non-hardenable steels. However, the method is used with particular preference for hardening hardenable carbon steels, in particular for producing a carbon-containing steel strip having a bainitic microstructure. According to the invention, in order to produce a steel strip having a bainitic microstructure, the lower, second temperature is thus selected such that it lies in the bainitization range of the steel strip, and after the cooling the steel strip is held at this second temperature for the quasi-isothermal formation of a bainite microstructure.

A hydrogen-containing gas mixture, for example a mixture of hydrogen and nitrogen, is used with particular preference as the quenchant. The hydrogen proportion of the gas mixture used as the quenchant is preferably between 50% by volume and 100% by volume. Hydrogen is particularly preferred as the coolant on account of its high thermal conductivity, or more precisely owing to the resultant high heat transfer coefficient. The heat transfer coefficient from a surface to a fluid flowing around the surface is defined as the ratio of heat conductivity and thickness of the thermal boundary layer of the fluid at the surface. For nitrogen/hydrogen gas mixtures, a maximum heat transfer coefficient is achieved given a hydrogen proportion of approximately 85% by volume. However, other gases with a suitably high heat conductivity can also be used in addition to or as an alternative to the hydrogen. On account of the fact that the quenchant is guided in a circuit, the loss of hydrogen in the cooling circuit is low and is optionally replaced continuously.

According to a preferred variant of the method according to the invention, the surface of the steel strip can be decarburized in a humid, hydrogen-containing nitrogen atmosphere before the austenitization in an upstream furnace or even during the austenitization in the same furnace. The surface decarburization typically takes place in a comparable temperature range to the austenitization, and therefore both processes can be carried out in the same furnace. To this end, use is typically made of a gas mixture of hydrogen, nitrogen and water vapor, for example an atmosphere of 15% by weight hydrogen gas and nitrogen with a water proportion, such that a dew point of approximately 39° C. is set.

If the steel strip is heated to a temperature of usually more than 900° C. in the surface decarburization furnace or the austenitization furnace, the superficial contamination typically still present on the steel strip, for example oil residues from the preceding processing steps, cracks. In order that these residues do not stick on the surface of the strip, the humid, hydrogen-containing nitrogen atmosphere is preferably guided in countercurrent to the direction of transport of the steel strip, such that the contamination is removed and can be guided out of the furnace.

After the method according to the invention, i.e. for example after the formation of the bainite microstructure, the steel strip can be cooled to room temperature and processed further, for example by the steel strip being divided into individual lines of relatively small width by longitudinal division, these then forming the later cutting lines, for example. To this end, after the longitudinal division, it is possible to harden at least one edge of the resultant lines, this later forming the cutting edge of the cutting lines.

Immediately following the method according to the invention, for example after the formation of the bainite microstructure, however, it is particularly preferable that the steel strip is tempered to the desired final strength at a relatively high temperature, i.e. for example at a temperature above the bainitization range. By way of example, the tempering can be effected at a temperature of between 300° C. and 600° C., typically at a temperature of 400° C., in a hydrogen-containing nitrogen atmosphere. The tempering is typically effected for a period of time of a few minutes, for example for a period of time of one minute. The hydrogen proportion of the inert nitrogen atmosphere used for the tempering can be between 1 and 10% by volume, preferably approximately 5% by volume.

In the method according to the invention, use is preferably made of a steel strip which consists of a steel with a carbon content of between 0.2 and 1.25% by weight. Steels of this type comprise, for example, martensitically hardenable chromium steels or rnartensitically handenable carbon steels. In order to form a bainitic microstructure, use is preferably made of a carbon-containing steel strip having a carbon content of between 0.3 and 0.8% by weight.

The invention moreover relates to an apparatus for producing a steel strip, in particular for carrying out the method according to the invention, which comprises an austenitization unit for heating a steel strip passing through to a first temperature above the austenitization temperature, and a quenching unit for quenching the steel strip passing through to a lower, second temperature selected in accordance with a desired steel microstructure, wherein the quenching unit comprises a feed device for feeding a temperature-controlled gaseous quenchant onto the steel strip passing through. The apparatus according to the invention is characterized in that the feed device is designed in such a way that uniform cooling is achieved over the width of the steel strip.

According to a preferred embodiment, the feed device comprises a plurality of nozzles, which are arranged above and below the steel strip passing through and can be used to blow the temperature-controlled gaseous quenchant onto the steel strip.

According to a preferred embodiment, the nozzles are designed in such a way as to produce a flow rate of the gaseous quenchant which varies over the width of the steel strip. It is thereby possible for the cooling rate to be set locally in such a way that edge effects are compensated for during the cooling and a temperature which is constant over the strip width is achieved.

According to one embodiment, the nozzles can be in the form of slotted nozzles, wherein at least some of the nozzles are arranged obliquely with respect to the steel strip passing through. As an alternative or in addition, the nozzles in the form of slotted nozzles can have openings with adjustable apertures, such that the width of the nozzles out of which the gaseous quenchant impinges on the steel strip passing through can be varied in the strip running direction. The apertures in this respect are preferably adjusted in such a way that initially only the central region of the strip running in is cooled, whereas in the following slotted nozzles the edges are increasingly also cooled.

For controlling the quenching, it is important, for example for the bainite formation, that firstly the cooling rate required for avoiding pearlite precipitation is achieved, and secondly the martensite starting temperature is not undershot. If the end temperature of the strip is used as a control variable, there is the risk that at the same time the cooling rate is changed and a critical value for quenching which is free of primary precipitation is undershot.

The combination of two or more independently controllable gas streams makes it possible to simultaneously satisfy the demands made in respect of cooling rate and end temperature. In a first step, the cooling rate can be kept at a high level, the end temperature in this step lying roughly considerably above the martensite starting temperature. In one or more further steps, the target temperature for the isothermal transformation can be set exactly by a relatively mild or temperature-controlled gas stream.

Two or more gas streams which are controllable independently of one another are therefore combined with particular preference in the method according to the invention and in the apparatus according to the invention, and therefore it is possible to simultaneously satisfy firstly the demands made in respect of the cooling rate and secondly the demand made in respect of keeping the end temperature constant, for example in the bainitization range.

The quenching unit moreover preferably comprises a circuit for the gaseous quenchant and optionally a feed line, via which it is possible to compensate for a loss of gaseous quenchant in the circuit from a storage container. The quenching unit moreover comprises suitable means, for example heat exchangers, for keeping the temperature of the gaseous quenchant at a desired value.

The invention will be explained in more detail hereinbelow with reference to an exemplary embodiment illustrated schematically in the accompanying drawing, in which:

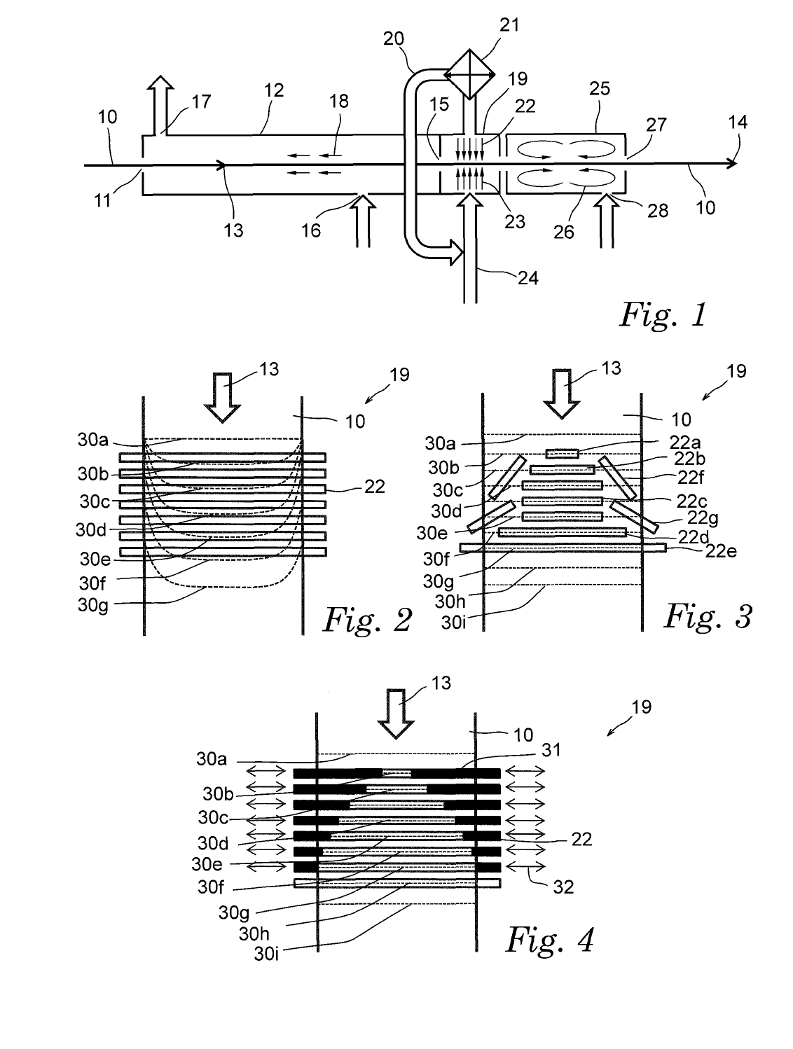

FIG. 1 shows a schematic illustration of an apparatus according to the invention for carrying out the method according to the invention;

FIG. 2 shows a slotted nozzle arrangement according to the prior art, in which a noticeable edge effect arises;

FIG. 3 shows a variant according to the invention of the slotted nozzle arrangement with in some cases obliquely placed slotted nozzles; and

FIG. 4 shows a further arrangement according to the invention of the slotted nozzles, in which the openings of the slotted nozzles have adjustable apertures.

FIG. 1 shows a steel strip 10, which is guided via a gap 11 into a furnace 12 for the austenitization and optionally also for the surface decarburization of the steel strip. The direction of transport of the steel strip is denoted by the arrows 13 and 14. In the furnace 12, the steel strip 10 is heated to a temperature of approximately 900° C. The steel strip 10 leaves the austenitization furnace again via a lock 15. A dry or humid atmosphere which, in addition to nitrogen, can optionally also contain hydrogen is present in the austenitization/surface decarburization furnace. The atmosphere is blown into the furnace via an inlet opening 16 located in the proximity of the lock 15, and can leave the furnace 12 again via an outlet opening 17, which is located in the proximity of the entry gap 11. As denoted by the arrows 18, the atmosphere is thereby guided in countercurrent to the strip 10 passing through, such that cracked contamination can be discharged with the gas stream. The austenitization furnace 12 is adjoined by a quenching unit 19, which is separated from the austenitization furnace by the lock 15. In the quenching unit 19, a gaseous quenchant (for example a hydrogen/nitrogen gas mixture) is guided in a temperature-controlled circuit 20. To this end, the circuit 20 comprises a cooling device 21, in order to keep the circulating gas at a constant temperature, this ensuring that the steel strip 10 entering into the quenching unit 19 is cooled in a range of seconds to a temperature in the bainitization range of the steel strip 10. To this end, the quenching unit 19 has a plurality of nozzles 22, 23, which are arranged above and below the steel strip and blow the gaseous quenchant onto the surface of the steel strip passing through. A feed 24 can be used to feed fresh gas to the circuit 20, in order to compensate for losses in the circuit, primarily losses via the lock 15 and further via the outlet opening 17. The quenching unit 19 is adjoined by a holding unit 25, in which the steel strip passing through is held at a temperature in the bainitization range, for example at a temperature of 400° C., such that a bainite microstructure can form in the steel strip. By way of example, the atmosphere in the holding furnace 25 consists of a hydrogen/nitrogen mixture, which is introduced via an inlet opening 28. The holding furnace 25 also has suitable temperature-control means (not shown in FIG. 1), which, on account of the convection prevailing in the furnace (represented schematically by the arrows 26), ensure that the formation of the bainite microstructure can be effected in a quasi-isothermal manner. The steel strip with the bainite microstructure formed therein leaves the apparatus according to the invention at the exit 27. Subsequently, further devices can provide for the post-treatment which is known per se, for example an annealing furnace and/or cutting devices for separating the steel strip into a plurality of strips.

FIG. 2 shows a plan view of a steel strip 10 in the region of a quenching unit 19 according to the prior art. The direction of transport of the steel strip 10 (strip running direction) is again symbolized by an arrow 13. According to the prior art, a plurality of slotted nozzles 22 are arranged transversely to the strip running direction for cooling the steel strip 10. The cooling gas flows out of these slotted nozzles 22 onto the steel strip 10. The dashed lines 30a-30g symbolize the temperature profile of the steel strip 10 on the basis of isotherms having a temperature which decreases from 30a-30g. The profile of the isotherms shows the edge effect which is associated with the prior art, with lower temperatures being reached significantly earlier at the edge than in the center of the steel strip owing to the greater cooling of the edges of the steel strip 10.

In order to compensate for this edge effect, it is proposed according to the invention to vary the flow rate of the gaseous quenchant over the width of the steel strip.

According to the variant proposed in FIG. 3, use is made of slotted nozzles 22a, 22b, 22c, 22d having a width which increases in the strip running direction 13, such that firstly only the central region of the steel strip 10 is cooled and it is only toward the end of the quenching unit 19 that the edge regions are also cooled. In order to further homogenize the temperature distribution, provision may be made of slotted nozzles 22f, 22g which are arranged obliquely with respect to the strip running direction 13.

According to the variant of the quenching unit according to the invention as shown in FIG. 4, provision is made, as in the prior art, of slotted nozzles 22 arranged transversely to the strip running direction 13, but according to the invention these are provided with apertures 31 which can be adjusted in such a way that firstly in turn only the central region of the steel strip 10 is cooled, while the edge regions are cooled only at the end of the quenching unit 19. As symbolized by the arrows 32, the apertures are preferably formed in a movable manner, such that the respective opening can be adapted to different steel grades, strip dimensions or cooling profiles.

Isotherms of decreasing temperature are shown in turn in FIGS. 3 and 4 by way of the reference signs 30a-30g. The special arrangement or screening of the slotted nozzles achieves a temperature which is constant over the width of the steel strip 10 during the cooling operation.

1-18. (canceled)

19: A method for producing a steel strip having a bainitic microstructure, comprising:
passing carbon-containing steel strip continuously through following treatments:
austenitization of the steel strip at a first temperature above the austenitization temperature;
quenching of the steel strip, by a quenchant, to a lower, second temperature lying in the bainitization range of the steel strip;
holding the steel strip at a temperature in the bainitization range for the quasi-isothermal formation of a bainite microstructure in the steel strip;
wherein
use is made of a gaseous quenchant, which is conducted onto the steel strip such that uniform cooling at a predefined cooling rate is achieved over the width of the steel strip, wherein the gaseous quenchant is guided in a temperature-controlled circuit and the flow rate of the gaseous quenchant is varied over the width of the steel strip.

20: The method as claimed in claim 19, wherein the gaseous quenchant is conducted onto the steel strip by two or more independently controllable gas streams.

21: The method as claimed in claim 19, wherein a hydrogen-containing gas mixture is used as the quenchant.

22: The method as claimed in claim 21, wherein the hydrogen proportion of the gas mixture used as the quenchant is between 50% by volume and 100% by volume.

23: The method as claimed in claim 19, wherein the surface of the steel strip is decarburized in a humid, hydrogen-containing nitrogen atmosphere before or during the austenitization.

24: The method as claimed in claim 23, wherein the humid, hydrogen-containing nitrogen atmosphere is guided in countercurrent to the direction of transport of the steel strip.

25: The method as claimed in claim 19, wherein the steel strip is tempered to final strength at a relatively high temperature in a hydrogen-containing nitrogen atmosphere after formation of the microstructure.

26: The method as claimed in claim 25, wherein the hydrogen proportion in the nitrogen atmosphere is between 1 and 10% by volume.

27: The method as claimed in claim 19, wherein the steel strip consists of a steel having a carbon content of between 0.3 and 0.8% by weight.

28: An apparatus for producing a steel strip having a bainitic microstructure, comprising:
an austenitization unit heating a steel strip passing through to a first temperature above the austenitization temperature;
a quenching unit quenching the steel strip passing through to a lower, second temperature lying in the bainitization range of the steel strip, wherein the quenching unit comprises a feed device for feeding a temperature-controlled gaseous quenchant onto the steel strip passing through; and
a holding unit for holding the steel strip at a temperature in the bainitization range for the quasi-isothermal formation of a bainite microstructure in the steel strip;
wherein
the feed device is configured such that uniform cooling at a predefined cooling rate is achieved over the width of the steel strip, wherein the feed device comprises a plurality of nozzles, which are arranged above and below the steel strip passing through and are configured to produce a flow rate of the gaseous quenchant which varies over the width of the steel strip.

29: The apparatus as claimed in claim 28, wherein the nozzles are in a form of slotted nozzles, wherein at least some of the nozzles are arranged obliquely with respect to the steel strip passing through.

30: The apparatus as claimed in claim 28, wherein the nozzles are in a form of slotted nozzles, openings of which have adjustable apertures.

31: A steel strip having a bainitic microstructure, obtained with the method of claim 19.

32: A steel srip as claimed in claim 31, wherein the steel strip is a spring steel strip, a punching tool, or a cutting line.
